(19) United States
(12) Patent Application Publication
(10) Pub. No.: US 2008/0193738 A1
(43) Pub. Date: Aug. 14, 2008

(54) Impregnated Foam

(76) Inventors: Lester Hensley, Westborough, MA (US); William Witherspoon, Guelph (CA)

Correspondence Address: MINTZ, LEVIN, COHN, FERRIS, GLOVSKY AND POPEO, P.C;ATTN: PATENT INTAKE CUSTOMER NO. 64046, ONE FINANCIAL CENTER, BOSTON, MA, 02111, US

(21) Appl. No.: 12/037,008

(22) Filed: Feb. 25, 2008

Related U.S. Application Data
(63) Continuation of application No. PCT/US2005/036849, filed on Oct. 4, 2005.

(51) Int. Cl. B32B 27/14; B05D 7/22

(52) U.S. Cl. 428/308.4; 427/181

(57) ABSTRACT

An impregnated foam comprises a flexible cellular foam impregnated with a chemical agent in which a plurality of particles having dimensions of 100 micrometers or less are dispersed. The foam can be compressed between two structural elements to form, e.g., a joint sealant; an expansion joint; a closure; a gap filler; a gasket; or a sealing, insulating, acoustical or anti-vibration sheet or blanket. Inclusion of the fine particles enables the use of less chemical agent or a lower degree of compression to obtain the same sealant performance as previous impregnated foams.

### CROSS-REFERENCE TO RELATED APPLICATIONS

This application claims the benefit of U.S. provisional patent application Ser. No. 60/710,625, filed on Aug. 23, 2005 and entitled “Impregnated Foam” which is incorporated by reference herein in its entirety. This application is a continuation under 35 U.S.C. §120 of co-pending Patent Cooperation Treaty Application serial no. PCT/US2005036849 filed on Oct. 14, 2005 and entitled “Impregnated Foam” which is incorporated by reference herein in its entirety.

### FIELD

The subject matter described herein relates to impregnated foams.

### BACKGROUND

An impregnated foam can be used as a joint sealant, expansion joint, closure, gap filler, gasket, sheet, or blanket. The impregnated foam sealant comprises a block, strip, sheet or extruded shape of flexible-cellular-foam material into or onto which is applied a quantity of a chemical agent that is compatible with the cellular foam.

The chemical agents that have traditionally been impregnated into foam include asphalts, bitumens, natural and chlorinated paraffin waxes, acrylics, latexes, styrene, vinyls, and resins. A sufficient quantity of chemical agent is forced into the flexible-cellular-foam material to render it water impermeable in a partially compressed state. However, the flexible-cellular-foam material is not filled so full of chemical agent that it loses its ability to re-expand with enough outwardly directed force to hold itself firmly in a joint. Moreover, as between the foam and the chemical agent, the greater cost is that of the chemical agent. There is therefore a need for an impregnated foam sealant product using less chemical agent than has heretofore been the case, but that nevertheless has acceptable sealing qualities.

One way of lowering the amount of adhesive required to be used, while still retaining the beneficial characteristics of an impregnated expanding foam sealant, is to combine layers of impregnated foam sealant with layers of substantially uncompressible, closed-cell foam, as taught in U.S. Pat. No. 5,935,695, the teachings of which can employed in conjunction with this disclosure and which are incorporated by reference herein in their entirety. The product taught therein can serve effectively as a joint filler but is somewhat complex to manufacture and less versatile in its suitability as a closure; gap filler; gasket; or sealing, insulating, acoustical, or anti-vibration sheet or blanket.

### SUMMARY

Disclosed herein is an impregnated foam comprising a flexible cellular foam. This flexible cellular foam is fully or partially impregnated with a chemical agent (e.g., an asphalt, a bitumen, a paraffin wax, an acrylic, a latex, a styrene, a vinyl, and/or a resin). Further still, a plurality of microparticles or nanoparticles having dimensions (e.g., a diameter) of 100 micrometers or less are dispersed in this chemical agent. The particles can be in the form, e.g., of hollow spheres.

The impregnated foam can be compressed between two structural elements to form a sealant, thereby serving, e.g., as a joint sealant; an expansion joint; a closure; a gap filler; a gasket; and a sheet or blanket used for sealing, insulating, or acoustical or vibrational absorption or damping.

The ability of an impregnated foam sealant to be water impermeable is a product of the impregnating chemical agent and the ultimate density of the material produced by compressing a volume of impregnated cellular foam to traditionally one fifth of its pre-compressed volume. The impregnated foam described herein, because it includes micro- or nanoparticles dispersed in a chemical agent, can be more resistant to water or more hydrophobic than previously used chemical agents so as to be able to reduce the amount of compression needed to achieve a degree of sealing comparable to that obtained with traditional impregnated foam sealants.

The impregnated compressible foam product can achieve sealing performance equivalent to what has previously been possible while utilizing less chemical agent at the same traditional degrees of foam compression. Alternatively, the impregnated compressible foam product can achieve sealing performance equivalent to what has previously been possible using similar amounts of chemical agent at lower degrees of foam compression.

Examples of particular applications in which the foam can be used include its use as joint sealant between building materials of all types, such as facade panels of concrete, stone, metal, glass, window systems; as an expansion joint in the vertical and horizontal planes between building materials of all types, such as concrete, steel, masonry, etc.; as an acoustical lining for engine compartments; as die-cut parts for gaskets in vehicles of all types; as log gaskets in the construction of log homes; as a gasket for sealing penetrations in recreational-vehicle (RV) windows; as seals between awnings and buildings; as gaskets within sun rooms, solariums, solar panels, as gaskets within or between civil engineering components, such as concrete pipes, curbing materials, roadway median barriers and bridge abutments; etc.

### BRIEF DESCRIPTION OF THE IMAGES

In the accompanying images, described below, like reference characters refer to the same or similar parts throughout the different views.

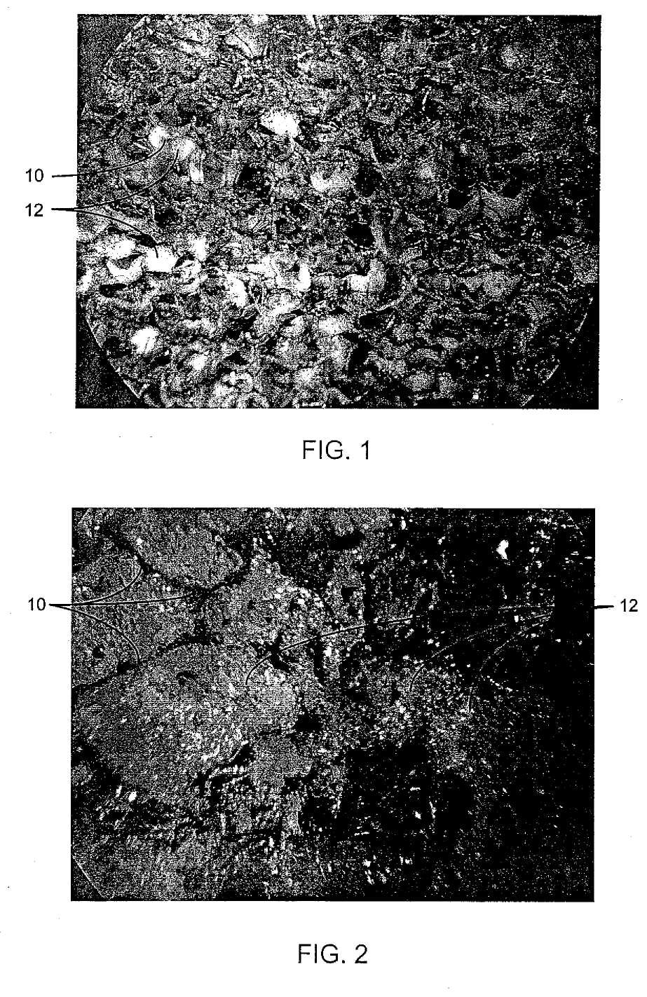

FIG. 1 is a magnified view (75 times) of the microstructure of foam impregnated with a chemical agent in which microparticles are dispersed.

FIG. 2 is a view at higher magnification (300 times) of the microstructure of foam impregnated with a chemical agent in which microparticles are dispersed.

### DETAILED DESCRIPTION

In an embodiment of the impregnated foam illustrated in FIGS. 1 and 2, the chemical agent 10 contains dispersed microparticles and coats the cell walls 12 of the cellular foam and/or partially or completely fills the foam cells throughout the foam matrix or at least in the region of the outer surface or surfaces of the flexible-cellular-foam material. The coated or impregnated flexible-cellular foam is then alternatively compressed and packaged in a compressed state or packaged in an uncompressed state in the form of sheets, rolls, blocks, coils, spools or other cut shapes. The impregnated foam can further have a pressure-sensitive mounting adhesive strip applied during manufacture to one or more of its surfaces. The material can further have a coating of another compatible material such as silicone, polyurethane, acrylic, fire-retardant, fungicide, or other coating materials applied during manufacture to one or more of the surfaces of the impregnated foam, either as a planar skin or tooled or otherwise formed into a bellows or other shape. The purpose of the coating can be to add additional features or characteristics, which may include but are not limited to color, enhanced ultra-violet light protection, an additional sealing element, a fire-retardant element, a component with a density different from that of the impregnated foam to broaden the spectrum of acoustic disruption, etc.

Where the impregnated foam is compressed for packaging, the material will begin to re-expand upon removal from the packaging towards its pre-compressed volume. Before the foam can re-expand, however, the foam is emplaned in a joint, void, or gap, such as in an expansion, contraction, settlement, isolation, panel, or other architectural or engineered joint in a building, for example between precast, stone, or metal panels or between other building materials of similar or dissimilar nature. After insertion in the joint the foam sealant continues to re-expand until it makes contact with both surfaces of the joint, where it will adhere to the joint surfaces by virtue of the pressure-sensitive mounting adhesive on one or more surfaces of the foam or by the combination of the stored-strain energy of pre-compression in the foam combined with the pressure-sensitive adhesive nature of the impregnating chemical agent. Once adhered to the joint surfaces and with normalization of the compression across the constrained foam section, the joint will be rendered water impermeable or near-impermeable.

Alternatively, uncompressed or fully re-expanded foam sealant can be positioned between two surfaces desired to be sealed and then compressed during the process of mechanically joining the surfaces by means of screws, fasteners or other constraints, to form a gasket between the surfaces to be sealed, such as between the log surfaces of a log-wall structure or between the metal to metal surfaces of a metal roof or building panel, or as a gasket between automotive or other components. The extent of compression and the resulting level of sealing desired and achieved is determined by the specific use or application at hand.

Alternatively, as a coated or uncoated sheet or blanket, the impregnated flexible-cellular foam material adhered to the walls of mechanical or electrical equipment enclosures acts as a dampener to noise and/or vibration, while additionally being flame retardant.

The cellular foam component in an impregnated foam sealant can be any suitable flexible-cellular-foam material that has a matrix of substantially open cells (pores) formed therein. The foam can have 20 to 150 pores per inch and in particular embodiments has from 50 to 80 pores per inch. Polyester or polyether polyurethane, polyvinyl copolymer, and viscose sponge-type foams are examples of foams that are suitable for use as the cellular-foam component.

The impregnated foam can be in the form of a block, strip, sheet or extruded shape of flexible-cellular-foam material, combined with a water-repelling chemical agent that coats the cellular foam cell walls and/or partially or completely fills the foam cells throughout the foam matrix or at least in the region of the outer surface or surfaces of the foam, wherein said chemical agent has a plurality of particles (e.g., in the form of nanospheres and/or microspheres) dispersed therein.

The particles are dispersed in a chemical agent that is used to impregnate or coat the cell walls of a flexible-cellular-foam material and/or partially or completely fills the cells of a cellular foam material throughout the foam matrix or at least in the region of the outer surfaces of the flexible-cellular-foam material to produce, e.g., a joint sealant, joint filler, gap filler, expansion joint, closure, gap filler; gasket; or sealing, insulating, acoustical, or anti-vibration sheet or blanket.

The particles can be small, spherical plastic particles in the range of 10 nm to 100 μm. The size of the particles is considered in relation to the cell size of the cellular foam material with larger particles being used with larger cellular-foam-cell sizes. The ratio of particles to total dispersion (i.e., particles and chemical agent) is in the range of 15-40% by volume, determined in part by the permeability of the particular cellular foam material in which the dispersion will be impregnated. A higher percentage of particles will generally be used where the permeability of the foam is higher. Permeability may, but will not always, increase with increasing porosity and cell size. Accordingly, the ratio of particles to total dispersion will often increase with increasing porosity or cell size. Alternatively or additionally, larger particles can be employed where there is greater permeability, porosity and/or cell size.

The particles can include a polymer shell, such as polyester, polyethylene or polypropylene, or other rigid or non-rigid material encapsulating a gas or other element. Alternatively, however, it will be understood that the particles can be solid and essentially non-compressible and that these solid spheres may function effectively, as well. Further still, instead of spheres, other shapes (e.g., ellipsoids) can be substituted.

The particles act to decrease the porosity of the foam by filling voids, thereby limiting water penetration in the foam matrix. Moreover, the particles are inherently flexible; consequently, the particles take compression well, and they expand with the foam during cycling, which may occur in the joint or where the material is acting as a gasket in the joining of surfaces. Moreover, the particles are hydrophilic in nature and, as such, swell when in the presence of water; the particles, therefore, act to further fill voids, thereby further limiting water penetration into the flexible-cellular-foam material. Use of hydrophilic material in a sealant is further discussed in U.S. Pat. No. 6,685,196, the teachings of which are incorporated by reference herein in their entirety.

The ratio, by weight, of foam to chemical agent (including the particles) can be in the range of 1:1 to 1:5 by volume, said ratio being determined in part by the permeability of the foam, wherein the amount of chemical agent and particles relative to the foam will generally increase with increasing permeability. Likewise, because greater porosity or cell size in the foam often produces higher permeability, more chemical agent and foam will, in many cases, be used where the porosity or cell size of the foam is greater. Alternatively or additionally, larger particles may be used where the porosity or cell size of the foam is greater.

The process by which the chemical agent can be infused into the cellular foam involves suspending the chemical agent in solution (e.g., in water or in another solvent) and then passing sheets of the cellular foam material through an apparatus suspended in a bath of the solution, where the apparatus compresses and releases the foam, allowing it to draw the solution (and therefore the chemical agent) into the cells of the foam, resulting in the cellular foam structure being thoroughly coated. The solvent is then driven off through a drying process, leaving the chemical agent dispersed throughout the cellular foam structure. Alternatively, the chemical agent is formulated (e.g., by introducing paraffin wax as a meltable medium) so as to be stable below a certain temperature and heated to make it flowable, at which point it is soaked or driven into the cellular foam material and then allowed to cool so as to be stable once again.

The manner in which the particle-modified-chemical agent is combined with the cellular foam can be through full or partial impregnation or infusion of all or part of the flexible cellular foam, or through the coating of one or more faces of the flexible-cellular-foam material with the chemical or in any other manner that results in a product of the combined materials.

In describing implementations or embodiments of the disclosed subject matter, specific terminology is used for the sake of clarity. For purposes of description, each specific term is intended to at least include all technical and functional equivalents that operate in a similar manner to accomplish a similar purpose. Additionally, in some instances where a particular implementation includes a plurality of system elements or method steps, those elements or steps may be replaced with a single element or step; likewise, a single element or step may be replaced with a plurality of elements or steps that serve the same purpose. Moreover, while this subject matter has been shown and described with references to particular implementations thereof, those skilled in the art will understand that various other changes in form and details may be made therein without departing from the scope of the subject matter which the inventors consider to be their inventions.

What is claimed:

1. An article of manufacture comprising:
a cellular foam material, the cellular foam material comprising a matrix of substantially open cells formed therein; and
a water-repelling chemical agent impregnating at least some of the open cells, the chemical agent comprising a dispersion of hydrophilic spheres, the hydrophilic particles having diameters of approximately 100 micrometers or less.

2. An article of manufacture as in claim 1, wherein the chemical agent is selected from a group consisting of asphalt, bitumen, natural paraffin wax, chlorinated paraffin wax, acrylic, latex, styrene, vinyl, and resin.

3. An article of manufacture as in claim 1, wherein the particles are approximately spherical in shape.

4. An article of manufacture as in claim 1, wherein the particles are approximately ellipsoidal in shape.

5. An article of manufacture as in claim 1, wherein the particles comprise a rigid material that encapsulates a gas.

6. An article of manufacture as in claim 1, wherein the particles comprise a non-rigid material that encapsulates a gas.

7. An article of manufacture as in claim 1, wherein the particles are solid and essentially non-compressible.

8. An article of manufacture as in claim 1, wherein the particles are reversibly compressible under pressure.

9. An article of manufacture as in claim 1, wherein the particles comprise polyester, polyethylene, or polypropylene.

10. An article of manufacture as in claim 1, wherein the chemical agent and the dispersion of hydrophilic particles partially fills at least some of the open cells.

11. An article of manufacture as in claim 1, wherein the hydrophilic particles comprise approximately 15% to 40% of the total chemical agent volume.

12. An article of manufacture as in claim 1, wherein the ratio of the weight of the cellular foam material to the weight of the hydrophilic particles and the chemical agent is in a range of approximately 1:1 to 1:5.

13. An article of manufacture as in claim 1, wherein the cellular foam material contains approximately 20 to 150 open cells per cubic inch of the cellular foam material.

14. An article of manufacture as in claim 1, wherein the cellular foam material contains approximately 50 to 80 open cells per cubic inch of the cellular foam material.

15. An article of manufacture as in claim 1, further comprising a pressure-sensitive mounting adhesive strip applied to an external surface of the cellular foam material.

16. A structure comprising:
a pair of structural elements defining a gap between them; and
a cellular foam material as in claim 1 compressed in the gap between the pair of structural elements.

17. A method of manufacture comprising:
submerging a cellular foam material in a bath comprising a water-repellent chemical agent and a plurality of hydrophilic particles having diameters of approximately 100 micrometers, the cellular foam material comprising a plurality of cells;
compressing and releasing the cellular foam material with an apparatus that is suspended in the bath;
allowing the cellular foam material to draw the water-repellent chemical agent and the plurality of hydrophilic particles into the plurality of cells in the cellular foam material; and
removing the cellular foam material from the bath.

18. A method of manufacture as in claim 17, wherein the bath further comprises a solvent in which the chemical agent and the plurality of hydrophilic particle are suspended and wherein the method further comprises driving off the solvent after removing the cellular foam material from the bath, thereby leaving the chemical agent and the particles dispersed within the plurality of cells in the cellular foam material.

19. A method of manufacture as in claim 17, further comprising compressing the cellular foam material and packaging the cellular foam material in a manner that maintains the compressible foam material in a compressed state for transport and/or storage.

20. A method comprising compressing a cellular foam material in a gap between two structural elements, the cellular foam material comprising a matrix of substantially open cells formed therein, and a water-repelling chemical agent impregnating at least some of the open cells, the chemical agent comprising a dispersion of hydrophilic spheres, the hydrophilic particles having diameters of approximately 100 micrometers or less.
